(19) United States
(12) Patent Application Publication
(10) Pub. No.: US 2021/0018779 A1
(43) Pub. Date: Jan. 21, 2021

(54) DISPLAY DEVICE

(71) Applicant: Samsung Display Co., Ltd., Yongin-Si (KR)

(72) Inventors: Beom Hee HAN, Hwaseong-si (KR); Je Hyeong PARK, Seoul (KR); Wan NAMGUNG, Asan-si (KR); Ji Eun PARK, Anyang-si (KR); Dong Kyun SEO, Asan-si (KR); Ki Pyo HONG, Hwaseong-si (KR)

(21) Appl. No.: 16/786,886

(22) Filed: Feb. 10, 2020

(30) Foreign Application Priority Data
Jul. 18, 2019 (KR) 10-2019-0087147

(51) Int. Cl. G02F 1/1362; G02F 1/1339; G02F 1/1368; G02F 1/1343

(52) U.S. Cl. CPC G02F 1/1362; G02F 1/13394; G02F 1/1368; G02F 2001/13396; G02F 2001/134345; G02F 2001/136222; G02F 1/134309

(57) ABSTRACT

A display device may include the following elements: a transistor; a pixel electrode electrically connected to the transistor; a first color filter overlapping the pixel electrode; a first color filtering member including a same material as the first color filter; a second color filter partially overlapping the first color filter or immediately neighboring the first color filter; a third color filter overlapping the first color filtering member and partially overlapping the second color filter or immediately neighboring the second color filter; a main spacer overlapping the third color filter; and an auxiliary spacer overlapping the first color filter or the second color filter and being shorter than the main spacer. The third color filter includes a first portion and a second portion. The first portion overlaps the first color filtering member. The second portion neighbors the first portion and is thicker than the first portion.

### CROSS-REFERENCE TO RELATED APPLICATION

This application claims priority to and the benefit of Korean Patent Application No. 10-2019-0087147 filed in the Korean Intellectual Property Office on Jul. 18, 2019; the entire contents of the Korean Patent Application are incorporated herein by reference.

### BACKGROUND

### (a) Field

The technical field relates to a display device.

### (b) Description of the Related Art

A liquid crystal display device may include a display panel for displaying images. The display panel includes a liquid crystal layer including liquid crystal molecules, field generating electrodes for controlling orientations of the liquid crystal molecules, signal lines for applying signals to the field generating electrodes, and switching elements for controlling transmission of the signals. When voltages are applied to the field generating electrodes, electric fields are generated to the liquid crystal layer to orient the liquid crystal molecules, for controlling transmission of light to display desired images.

The above information disclosed in this Background section is for enhancement of understanding of the background of the application. The Background section may contain information that does not form the prior art that is already known in this country to a person of ordinary skill in the art.

### SUMMARY

Embodiments may be related to a display device that includes a transistor with a minimum change of a threshold voltage and/or includes a structurally stable spacer.

An embodiment provides a display device including: a transistor provided on a substrate; a pixel electrode electrically connected to the transistor; a first color filter provided between the transistor and the pixel electrode; a color filtering member including a same material as the first color filter; a second color filter and a third color filter overlapping the color filtering member; and a main spacer and an auxiliary spacer provided on the pixel electrode, wherein the second color filter and the third color filter respectively include a first portion overlapping the color filtering member and a second portion excluding the first portion, a thickness of the first portion is less than a thickness of the second portion, and the main spacer overlaps the third color filter, while the auxiliary spacer overlaps at least one of the first color filter and the second color filter.

The auxiliary spacer may overlap the first color filter.

Regarding the third color filter, a straight line to an upper side of the first portion from the substrate may substantially correspond to a straight line to an upper side of the second portion from the substrate.

The second color filter may overlap the auxiliary spacer.

The auxiliary spacer may overlap the color filtering member.

The auxiliary spacer may overlap a first portion of the second color filter and part of the second portion.

Regarding the second color filter, a straight line to an upper side of the first portion from the substrate may substantially correspond to a straight line to an upper side of the second portion from the substrate.

A transistor overlapping the second color filter may include a first transistor and a second transistor, the color filtering member may overlap the first transistor and the second transistor, and the auxiliary spacer may overlap the first transistor and the second transistor.

A maximum thickness of the third color filter may be greater than a maximum thickness of the respective first color filter and second color filter.

The first color filter may be a red color filter, and the third color filter may be a blue color filter.

The color filtering member may overlap a transistor overlapping the second color filter and a transistor overlapping the third color filter.

The transistor may include a first transistor and a second transistor, and the main spacer may be provided between the first transistor and the second transistor.

The auxiliary spacer may include a region overlapping the first transistor and the second transistor in a first direction, and a region protruding in a second direction that is perpendicular to the first direction.

The color filtering member may simultaneously overlap the first transistor and the second transistor.

Another embodiment provides a display device including: a transistor provided on a first substrate; a pixel electrode electrically connected to the transistor; a first color filter, a second color filter, and a third color filter overlapping the pixel electrode; a color filtering member overlapping the second color filter and the third color filter; a main spacer and an auxiliary spacer provided on the pixel electrode; a second substrate overlapping the first substrate; and a liquid crystal layer provided between the first substrate and the second substrate, wherein a straight line to an upper side of the first color filter from an upper side of the substrate substantially corresponds to a straight line to an upper side of the second color filter from an upper side of the substrate, the auxiliary spacer overlaps at least one of the first color filter and the second color filter, and the auxiliary spacer is provided between first substrate and the liquid crystal layer.

A straight line to an upper side of the third color filter from an upper side of the substrate may be greater than a straight line to an upper side of the first color filter from an upper side of the substrate.

The third color filter may overlap the main spacer.

The auxiliary spacer may overlap the second color filter and the color filtering member.

The main spacer may overlap the color filtering member.

The main spacer may be separated from the color filtering member in a plan view.

An embodiment may be related to a display device. The display device may include a substrate, a first transistor, a first pixel electrode, a first color filter, a first color filtering member, a second color filter, a third color filter, a main spacer, and an auxiliary spacer. A first direction may be parallel to a face of the substrate. A second direction may be parallel to the face of the substrate and may be perpendicular to the first direction. A third direction may be perpendicular to the face of the substrate. The first transistor may overlap the face of the substrate. The first pixel electrode may be electrically connected to the first transistor. The first color filter may overlap the first pixel electrode. The first color filtering member may include a same material as the first color filter. The second color filter may partially overlap the first color filter or immediately neighbor the first color filter. The third color filter may overlap the first color filtering member, may be spaced from the first color filter, and may partially overlap the second color filter or immediately neighbor the second color filter. The main spacer may overlap the third color filter. The auxiliary spacer may overlap at least one of the first color filter and the second color filter and may be shorter than the main spacer in the third direction. The third color filter may include a first portion and a second portion. The first portion may overlap the first color filtering member. The second portion may neighbor the first portion in the first direction and may be thicker than the first portion in the third direction.

The auxiliary spacer may overlap the first color filter.

A face of the first portion may be spaced from the first color filtering member, may be parallel to the face of the substrate, and may be coplanar with a face of the second portion.

The second color filter may overlap the auxiliary spacer.

The display device may include a second color filtering member, which may include the same material as the first color filter. The auxiliary spacer may overlap the second color filtering member.

The auxiliary spacer may be wider than the second color filtering member in the first direction.

The display device may include a second color filtering member, which may include the same material as the first color filter. The second color filter may include a first part and a second part. The first part may overlap the second color filtering member. The second part may neighbor the first part in the first direction. A face of the first part may be spaced from the second color filtering member, may be parallel to the face of the substrate, and may be coplanar with a face of the second part.

The display device may include the following elements: a second pixel electrode overlapping the second color filter and may include a first sub-pixel electrode and a second sub-pixel electrode; a second transistor electrically connected to the first sub-pixel electrode; and a third transistor electrically connected to the second sub-pixel electrode. The second color filtering member may overlap both the second transistor and the third transistor. The auxiliary spacer may overlap both the second transistor and the third transistor.

A maximum thickness of the third color filter in the third direction may be greater than each of a maximum thickness of the first color filter in the third direction and a maximum thickness of the second color filter in the third direction.

The first color filter may be a red color filter. The third color filter may be a blue color filter.

The display device may include the following elements: a second pixel electrode overlapping the second color filter; a second transistor electrically connected to the second pixel electrode; a second color filtering member overlapping the second transistor, The second color filter may overlap the second color filtering member; a third pixel electrode overlapping the third color filter; and a third transistor electrically connected to the third pixel electrode. The first color filtering member may overlap the third transistor.

The display device may include the following elements: a second transistor electrically connected to the first pixel electrode; a first sub-pixel electrode overlapping the third color filter; a second sub-pixel electrode overlapping the third color filter; a third transistor electrically connected to the first sub-pixel electrode; and a fourth transistor electrically connected to the second sub-pixel electrode. The main spacer may be provided between the third transistor and the fourth transistor.

The auxiliary spacer may include a first part and a second part. The first part may overlap both the first transistor and the second transistor. The second part may protrude in the second direction from the first part.

The display device may include the following elements: a first sub-pixel electrode overlapping the third color filter; a second sub-pixel electrode overlapping the third color filter; a second transistor electrically connected to the first sub-pixel electrode; and a third transistor electrically connected to the second sub-pixel electrode. The first color filtering member may overlap both the second transistor and the third transistor.

An embodiment may be related to a display device. The display device may include the following elements: a first substrate; a second substrate overlapping the first substrate; a liquid crystal layer positioned between the first substrate and the second substrate; a transistor overlapping a face of the first substrate and may be positioned closer to the first substrate than to the second substrate; a first color filter, a second color filter, and a third color filter overlapping the face of the first substrate, wherein the second color filter may be substantially positioned between the first color filter and the third color filter; a pixel electrode electrically connected to the transistor and overlapping at least one of the first color filter, the second color filter, and the third color filter; a color filtering member including a same material as the first color filter and overlapping the second color filter or the third color filter; a main spacer and an auxiliary spacer positioned between the first substrate and the second substrate. A first face of the first color filter may be positioned between the second substrate and a second face of the first color filter. A first face of the second color filter may be positioned between the second substrate and a second face of the second color filter. The first face of the first color filter may be substantially coplanar with the first face of the second color filter. The auxiliary spacer may be shorter than the main spacer in a direction perpendicular to the face of the first substrate, may overlap at least one of the first color filter and the second color filter, and may be provided between first substrate and the liquid crystal layer.

A first face of the third color filter may be positioned between the second substrate and a second face of the third color filter and may be positioned closer to the second substrate than the first face of the first color filter is positioned.

The third color filter may overlap the main spacer.

The auxiliary spacer may overlap both the second color filter and the color filtering member.

The main spacer may overlap the color filtering member.

The main spacer may be separated from the color filtering member in a plan view of the display device.

Embodiments may minimize unwanted change of the threshold voltage of a transistor in a display device and may optimize the reliability of the display device.

### BRIEF DESCRIPTION OF THE DRAWINGS

FIG. 1 shows a layout view (or plan view) of three adjacent pixel areas of a display device according to an embodiment.

FIG. 2 shows a cross-sectional view with respect to a line IIa-IIb shown in FIG. 1 according to an embodiment.

FIG. 3 shows a cross-sectional view with respect to a line IIIa-IIIb shown in FIG. 1 according to an embodiment.

FIG. 4 shows a layout view of part of three adjacent pixel areas of a display device according to an embodiment.

FIG. 5 shows a cross-sectional view with respect to a line IVa-IVb shown in FIG. 4 according to an embodiment.

FIG. 6 shows a layout view of part of three adjacent pixel areas of a display device according to an embodiment.

FIG. 7 shows a layout view of part of three adjacent pixel areas of a display device according to an embodiment.

FIG. 8 shows a layout view of part of three adjacent pixel areas of a display device according to an embodiment.

FIG. 9 shows a layout view of part of three adjacent pixel areas of a display device according to an embodiment.

FIG. 10 shows a cross-sectional view with respect to a line Xa-Xb of FIG. 9 according to an embodiment.

FIG. 11 shows a graph of a stain generating leakage voltage according to an embodiment.

FIG. 12A and FIG. 12B each show an image of part of a region of a display device according to a comparative example.

FIG. 13 shows an image of part of a region of a display device according to an embodiment.

### DETAILED DESCRIPTION OF EMBODIMENTS

Example embodiments are described with reference to the accompanying drawings. The described embodiments may be modified in various different ways.

The drawings and description are illustrative in nature and are not restrictive. Like reference numerals may designate like elements.

In the drawings, dimensions of elements may be exaggerated for clarity.

Although the terms “first,” “second,” etc. may be used to describe various elements, these elements should not be limited by these terms. These terms may be used to distinguish one element from another element. A first element may be termed a second element without departing from teachings of one or more embodiments. The description of an element as a “first” element may not require or imply the presence of a second element or other elements. The terms “first,” “second,” etc. may be used to differentiate different categories or sets of elements. For conciseness, the terms “first,” “second,” etc. may represent “first-type (or first-set),” “second-type (or second-set),” etc., respectively.

When a first element is referred to as being “on” a second element, the first element can be directly on the second element, or one or more intervening elements may be present between the first element and the second element. When a first element is referred to as being “directly on” a second element, there are no intervening elements (except environmental elements such as air) present between the first element and the second element. The word “on” or “above” may mean “overlapping” or “below” and may not necessarily mean being positioned on the upper side of an object based on a gravitational direction.

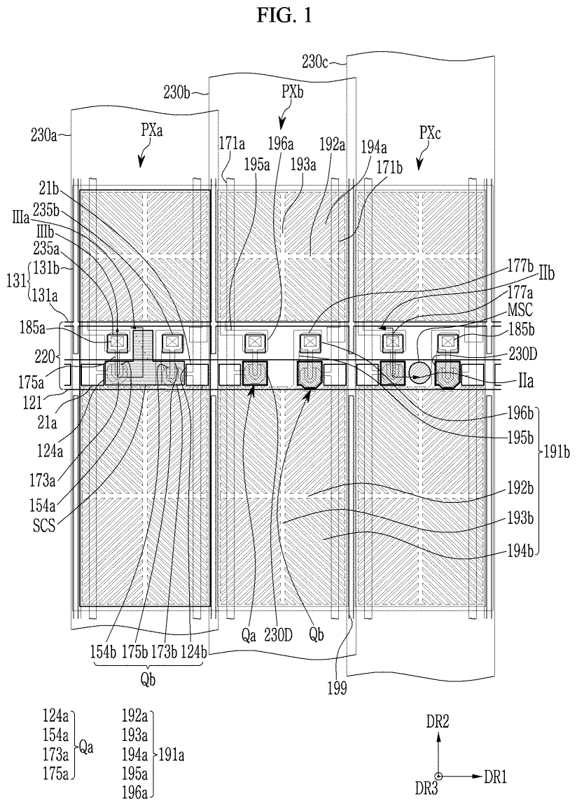

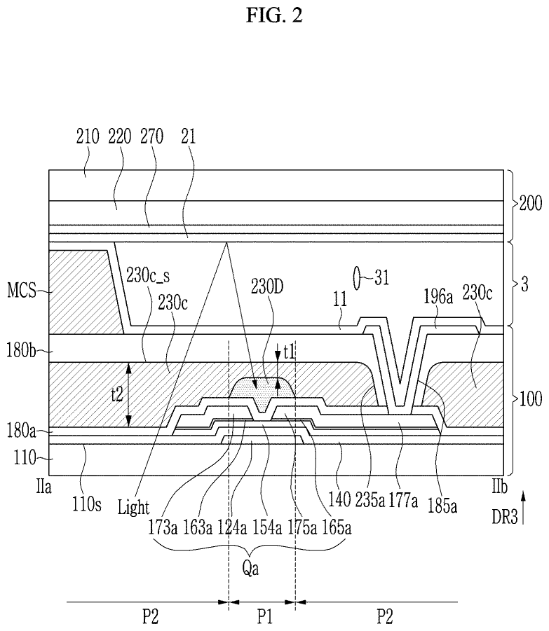

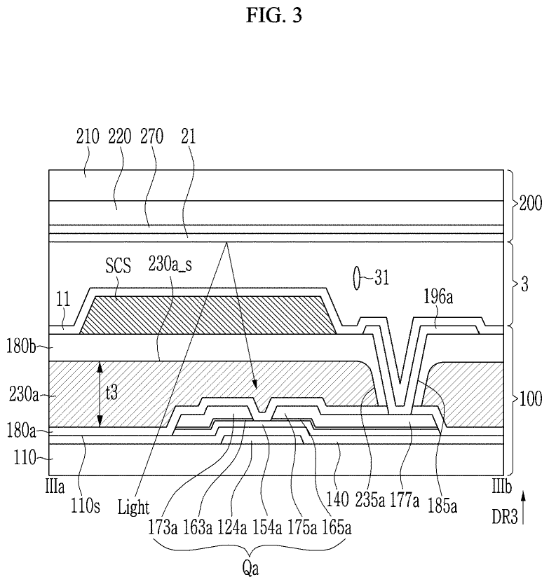

Unless explicitly described to the contrary, the word “comprise” and variations such as “comprises” or “comprising” may imply the inclusion of stated elements but not the exclusion of any other elements. The term “the same as” may mean “equal to.” The term “different from” may mean “unequal to.” The term “side” may mean “face.” FIG. 1 shows a layout view of three adjacent pixel areas of a display device according to an embodiment, FIG. 2 shows a cross-sectional view with respect to a line IIa-IIb shown in FIG. 1 according to an embodiment, and FIG. 3 shows a cross-sectional view with respect to a line IIIa-IIIb shown in FIG. 1 according to an embodiment.

Referring to FIG. 1, FIG. 2, and FIG. 3, the display device includes a display area for displaying an image in a plan view, and the display area includes a plurality of pixel areas PXa, PXb, and PXc. Each pixel area set may include pixel areas analogous to the illustrated pixel areas PXa, PXb, and PXc, and pixel area sets may be arranged in a first direction DR1.

The display device may include a first display panel 100, a second display panel 200 overlapping the first display panel 100, and a liquid crystal layer 3 provided between the first display panel 100 and the second display panel 200.

The first display panel 100 includes a gate line 121 and a storage electrode line 131 provided on a first substrate 110 that may include an insulating material such as glass or plastic.

The gate line 121 mainly extends in the first direction DR1, and it may transmit a gate signal. The gate line 121 may include a first gate electrode 124a and a second gate electrode 124b provided in the pixel areas PXa, PXb, and PXc.

The gate line 121 may include openings 21a and 21b. Each of the openings may be provided between a second gate electrode 124b of a pixel area PXa/PXb/PXc and a first gate electrode 124a of an immediately neighboring pixel area PXa/PXb/PXc and may be generated by removing part of the gate line 121. In a pixel area, the opening 21a may be provided closer to the first gate electrode 124a than to the second gate electrode 124b, and the opening 21b may be provided closer to the second gate electrode 124b than to the first gate electrode 124a.

The storage electrode line 131 may include a horizontal unit 131a extending substantially parallel to the gate line 121, and may include a vertical unit 131b connected to the horizontal unit 131a. The vertical unit 131b of the storage electrode line 131 may extend along a border between two immediately adjacent pixel areas of pixel areas PXa, PXb, and PXc.

A gate insulating layer 140 is provided on the conductive lines 121 and 131. The gate insulating layer 140 may include an inorganic insulating material such as silicon nitride (SiNx), silicon oxide (SiOx), or silicon oxynitride (SiON).

A first semiconductor layer 154a and a second semiconductor layer 154b are provided on the gate insulating layer 140. The first semiconductor layer 154a may overlap the first gate electrode 124a, and the second semiconductor layer 154b may overlap the second gate electrode 124b.

The semiconductor layers 154a and 154b may include amorphous silicon, polycrystalline silicon, or a metal oxide.

Ohmic contact members 163a and 165a are provided on the semiconductor layers 154a and 154b. A pair of ohmic contact members 163a and 165a may be provided on the first semiconductor layer 154a, and another pair of ohmic contact members (not shown) may be provided on the second semiconductor layer 154b.

The ohmic contact members may be made of silicide or n+ hydrogenated amorphous silicon doped with an n-type impurity at a high concentration. The ohmic contact members 163a and 165a may be optional depending on embodiments.

A first drain electrode 175a and a second drain electrode 175b are respectively provided on ohmic contact members 163a and 165a.

A first data line 171a and a second data line 171b may transmit data signals, may mainly extend in a second direction DR2, and may traverse the gate line 121 and the horizontal unit 131a of the storage electrode line 131.

The first data lines 171a and the second data lines 171b corresponding to respective pixel areas PXa, PXb, and PXc may transmit data voltages for expressing different luminance levels for one image signal. For example, the data voltage of an image signal with one gray transmitted by a second data line 171b may be equal to or less than the data voltage transmitted by the corresponding first data line 171a. The data lines 171a and 171b respectively provided in the adjacent pixel areas PXa, PXb, and PXc may transmit data voltages of individual image signals.

A first data line 171a may include a first source electrode 173a overlapping the corresponding first gate electrode 124a, and a second data line 171b may include a second source electrode 173b overlapping the corresponding second gate electrode 124b.

A first drain electrode 175a and a second drain electrode 175b may respectively include extensions 177a and 177b each including a bar-type end and a wide end. The extensions 177a and 177b of the first drain electrode 175a and the second drain electrode 175b may be provided between the storage electrode line 131 and the gate line 121.

The bar-type ends of the first drain electrode 175a and the second drain electrode 175b may be partly surrounded by the first source electrode 173a and the second source electrode 173b.

The first gate electrode 124a, the first source electrode 173a, and the first drain electrode 175a constitute a first transistor Qa together with the first semiconductor layer 154a. The second gate electrode 124b, the second source electrode 173b, and the second drain electrode 175b constitute a second transistor Qb together with the second semiconductor layer 154b. Respective channels of the transistors Qa and Qb may be provided in the first semiconductor layer 154a between the first source electrode 173a and the first drain electrode 175a and in the second semiconductor layer 154b between the second source electrode 173b and the second drain electrode 175b.

The first and second transistors Qa and Qb provided in the respective pixel areas PXa, PXb, and PXc may be arranged in the first direction DR1. Further, in a plan view, transistors Qa and Qb may be provided between the first data line 171a and the second data line 171b corresponding to the associated pixel area PXa/PXb/PXc.

The transistors Qa and Qb may function as switching elements for transmitting data voltages transmitted by the data lines 171a and 171b according to the gate signal transmitted by the gate line 121.

Referring to FIG. 1 and FIG. 2, the gate line 121, the horizontal unit 131a of the storage electrode line 131, and the first and second transistors Qa and Qb may be covered by a light blocking member 220. The light blocking member 220 may generally extend in the first direction DR1.

A first insulating layer 180a is provided on the conductive elements 171a, 171b, 175a, and 175b. The first insulating layer 180a may include an organic insulating material or an inorganic insulating material.

Color filters 230a, 230b, and 230c and a color filtering member 230D may be provided on the first insulating layer 180a.

The color filters 230a, 230b, and 230c may express three primary colors (such as red, green, and blue) or four primary colors. The color filters 230a, 230b, and 230c may express cyan, magenta, yellow, and white-based basic colors. For example, the first color filter 230a may express red, the second color filter 230b may express green, and the third color filter 230c may express blue.

The first color filter 230a may overlap (or may be positioned in) the first pixel area PXa, the second color filter 230b may overlap the second pixel area PXb, and the third color filter 230c may overlap the third pixel area PXc. Each of the color filters 230a, 230b, and 230c may extend in the second direction DR2 to overlap a plurality of pixel areas provided in a column. Color filter groups each including three color filters 230a, 230b, and 230c may be arranged in the first direction DR1.

Two of the color filters 230a, 230b, and 230c overlapping immediately adjacent two of pixel areas PXa, PXb, and PXc may overlap each other in a third direction DR3 on the first substrate 110. For example, the first color filter 230a of the first pixel area PXa may overlap the second color filter 230b of the immediately adjacent second pixel area PXb on the border between the two adjacent pixel areas PXa and PXb. An overlapping portion of the two color filters 230a and 230b may overlap the corresponding vertical unit 131b of the corresponding storage electrode line 131.

The two of the color filters 230a, 230b, and 230c overlapping each other may have a light blocking function of preventing leakage of light between the immediately adjacent two of pixel areas PXa, PXb, and PXc.

The color filters 230a, 230b, and 230c may include openings 235a and 235b exposing the extensions 177a and 177b of the corresponding drain electrodes 175a and 175b.

As shown in FIG. 3, the first color filter 230a may include an upper side/face (230a_s) substantially having a planar form in the first pixel area (PXa). Most distances to the upper side (230a_s) of the first color filter 230a from an upper side 110s of the first substrate 110 may be substantially equal in the first pixel area (PXa). However, as an exception, the first color filter 230a may have inclined portions in a cross-sectional view near the openings 235a and 235b included in the first color filter 230a.

As shown in FIG. 2, the third color filter 230c may include an upper side/face (230c_s) substantially having a planar form in the third pixel area (PXc). Most distances to the upper side (230c_s) of the third color filter 230c from the upper side 110s of the first substrate 110 may be substantially equal in the third pixel area (PXc). However, the third color filter 230c may have inclined portions in a cross-sectional view near the openings 235a and 235b included in the third color filter 230c.

The cross-section of the second color filter 230b may be analogous to the cross-section of the third color filter 230c.

A maximum thickness t2 of the third color filter 230c may be different from (unequal to) a maximum thickness t3 of the first color filter 230a. For example, the maximum thickness t2 of the third color filter 230c may be greater than the maximum thickness t3 of the first color filter 230a. Although not shown in FIG. 2 and FIG. 3, the maximum thickness of the second color filter 230b may be substantially the same as (equal to) the maximum thickness t3 of the first color filter 230a, and the maximum thickness of the second color filter 230b may be less than the maximum thickness of the third color filter 230c.

The color filtering member 230D may express the same color as the first color filter 230a, may be provided directly on the same insulating layer 180a directly contacted by the first color filter 230a, may include the same material as the first color filter 230a, and may be simultaneously formed in the same process for forming the first color filter 230a. For example, the color filtering member 230D may express red when the first color filter 230a is a red color filter. When the first color filter 230a is a green color filter, the color filtering member 230D may express green. When the first color filter 230a is a blue color filter, the color filtering member 230D may express blue.

The color filtering member 230D is separated from the first color filter 230a for expressing the same color in different pixel areas. Color filtering members 230D may be provided in pixel areas PXb and PXc, which include the color filters 230b and 230c for expressing colors that are different from the color of the first color filter 230a. Two color filtering members 230D may respectively overlap the second pixel area PXb and the third pixel area PXc.

The color filtering member(s) 230D provided in each of the pixel areas PXb and PXc may overlap at least one of the corresponding transistors Qa and Qb. In an embodiment, the color filtering member(s) 230D provided in each of the second pixel area PXb and the third pixel area PXc may overlap both the channels of the semiconductor layers 154a and 154b of the corresponding transistors Qa and Qb.

According to an embodiment, two color filtering members 230D may be provided in each of the pixel areas PXb and PXc and may respectively overlap two transistors. A number of color filtering members 230D included by each of the pixel areas PXb and PXc may depend on a number of transistors included by each of the pixel areas PXb and PXc.

The color filtering member 230D may have an island shape overlapping the transistor in a plan view, and without being limited thereto, it may have various shapes for overlapping the channel of the transistor.

The color filtering members 230D (and the overlapping portions of the corresponding color filter 230b or 230c) may absorb most of light transmitted toward the channels of the transistors Qa and Qb from an upper side to thus prevent the light from reaching the transistors Qa and Qb. Through this configuration, initial threshold voltages of the transistors Qa and Qb may be optimized, variations of the threshold voltages may be minimized, and unwanted changes of colors of displayed images may be minimized. Advantageously, satisfactory reliability of the display device may be attained.

Color filtering members 230D may be provided between the second color filter 230b and the substrate 110 and between the third color filter 230c and the substrate 110 in a cross-sectional view of the display device. In an embodiment, a color filtering member 230D may be provided between the second color filter 230b and the first insulating layer 180a, or between the third color filter 230c and the first insulating layer 180a. A color filtering member 230D may overlap the light blocking member 220. In a plan view, a color filtering member 230D may be positioned between two opposite edges of the light blocking member 220 in the second direction D2. A color filtering member 230D may be provided between the first data line 171a and the second data line 171b provided in one of the pixel areas PXb and PXc.

The third color filter 230c may include a first portion P1 overlapping the corresponding color filtering member 230D and may include a second portion P2 excluding the first portion P1. The thickness of the first portion P1 in the third direction D3 may be different from the thickness of the second portion P2 in the third direction D3. The thickness t1 of the first portion P1 may be less than the thickness t2 of the second portion P2. FIG. 2 and FIG. 3 do not illustrate a cross-section of the second color filter 230b. Analogous to the third color filter 230c, the second color filter 230b may include a first portion overlapping the color filtering member 230D and may include a second portion excluding the first portion, and the thickness of the first portion in the third direction D3 may be less than the thickness of the second portion in the third direction D3.

The opening 21a of the gate line 121 may expose part of the first data line 171a and the first source electrode 173a, and the opening 21b of the gate line 121 may expose part of the second data line 171b and the second source electrode 173b. When the pixel area has a defect, laser beams are irradiated to the first source electrode 173a and/or the second source electrode 173b through the opening(s) 21a and/or 21b to repair a defective pixel area by cutting the first transistor Qa and/or the second transistor Qb from the first data line 171a and/or the second data line 171b.

The color filtering member 230D may not be exposed by the openings 21a and 21b. Therefore, only one of the color filters 230a, 230b, and 230c is provided over the openings 21a and 21b of each of the pixel areas PXa, PXb, and PXc, so when the defective pixel area is repaired, there is a low possibility of generation of display defects such as a black spot that may be generated if the laser beams are irradiated to at least two overlapping color filters.

A second insulating layer 180b may be provided on the color filters 230a, 230b, and 230c and the color filtering members 230D. The second insulating layer 180b may include an inorganic insulating material or an organic insulating material. According to an embodiment, the second insulating layer 180b may include an organic insulating material and may provide a substantially flat upper side. The second insulating layer 180b may function as an overcoat on the color filters 230a, 230b, and 230c and the color filtering members 230D to prevent the color filters 230a, 230b, and 230c and the color filtering members 230D from being exposed, and prevent an impurity such as a pigment from entering the liquid crystal layer 3.

The first insulating layer 180a and the second insulating layer 180b include a contact hole 185a exposing the extension 177a of the first drain electrode 175a and include a contact hole 185b exposing the extension 177b of the second drain electrode 175b.

A first sub-pixel electrode 191a, a second sub-pixel electrode 191b, and a shield electrode 199 may be provided on the second insulating layer 180b. With respect to the region where the transistors Qa and Qb are provided in the pixel areas PXa, PXb, and PXc, the first sub-pixel electrode 191a may be provided on one side, and the second sub-pixel electrode 191b may be provided on its opposite side. The first sub-pixel electrode 191a and the second sub-pixel electrode 191b may be disposed in a second direction DR2.

Shapes of the first sub-pixel electrode 191a and the second sub-pixel electrode 191b may be quadrangular. The first sub-pixel electrode 191a may include a cross-shaped stem including a horizontal stem 192a and a vertical stem 193a, and may include a plurality of branches 194a extending from the cross-shaped stem. The second sub-pixel electrode 191b may include a cross-shaped stem including a horizontal stem 192b and a vertical stem 193b, and may include a plurality of branches 194b extending from the cross-shaped stem.

A planar area of the first sub-pixel electrode 191a may be less than a planar area of the second sub-pixel electrode 191b.

The first sub-pixel electrode 191a may include an extension 195a protruding toward the extension 177a of the first drain electrode 175a and a contact portion 196a connected to an end of the extension 195a. The second sub-pixel electrode 191b may include an extension 195b protruding toward the extension 177b of the second drain electrode 175b and a contact portion 196b connected to an end of the extension 195b. The contact portion 196a may be electrically connected to the extension 177a of the first drain electrode 175a through a contact hole 185a. The contact portion 196b is electrically connected to the extension 177b of the second drain electrode 175b through a contact hole 185b.

When the first transistor Qa and the second transistor Qb are turned on, the first sub-pixel electrode 191a and the second sub-pixel electrode 191b may receive data voltages from the first drain electrode 175a and the second drain electrode 175b.

A shield electrode 199 may include a vertical unit extending in the second direction DR2. Additionally or alternatively, it may include a horizontal unit extending in the first direction DR1. A shield electrode 199 may be provided between immediately adjacent two of pixel areas PXa, PXb, and PXc in the first direction DR1 and/or between immediately adjacent two of pixel areas PXa, PXb, and PXc in the second direction DR2. Shield electrodes 199 may prevent coupling between immediately adjacent pixel areas PXa, PXb, and PXc and leakage of light. The vertical unit of a shield electrode 199 may overlap a vertical unit 131b of the storage electrode line 131.

The pixel electrode layers 191a, 191b, and 199 may include a transparent conductive material such as indium-tin oxide (ITO) or indium zinc oxide (IZO), or may include a metal thin film.

Spacers MCS and SCS may be provided on the second insulating layer 180b.

Referring to FIG. 2, the display device may include a main spacer (MCS) provided in the third pixel area (PXc). The main spacer (MCS) may overlap the third color filter 230c. The main spacer (MCS) may be provided on a planar upper side (230cs) of the third color filter 230c. The main spacer (MCS) may not overlap the first pixel area (PXa) and the second pixel area (PXb), and may be separated from them. The main spacer (MCS) may not overlap the first color filter 230a and the second color filter 230b, and may be separated from them. The main spacer (MCS) may not overlap the color filtering member 230D provided in the second pixel area (PXb).

The main spacer (MCS) may be provided between the first transistor Qa and the second transistor Qb in the third pixel area (PXc). The main spacer (MCS) may be separated from the first transistor Qa and the second transistor Qb in a plan view. The main spacer (MCS) may not overlap the color filtering member 230D overlapping the third color filter 230c.

The first transistor Qa may be disposed at a different position. The main spacer (MCS) may have a substantially circular form or a different form in a plan view.

The main spacer (MCS) may maintain a gap between the first display panel 100 and the second display panel 200 in a regular non-pressurized state. The main spacer (MCS) need not be disposed in the third pixel area (PXc), and it may some of a plurality of third pixel areas (PXc) included by the display device.

The main spacer (MCS) may overlap the third color filter 230c. The maximum thickness t2 of the third color filter 230c may be thicker than the maximum thickness t3 of the first color filter 230a and the second color filter 230b. The main spacer (MCS) provided on the relatively thick third color filter 230c may be stably provided between the first display panel 100 and the second display panel 200.

Referring to FIG. 1 to FIG. 3, the display device may include an auxiliary spacer (SCS) provided in the first pixel area (PXa). The auxiliary spacer (SCS) may overlap the first color filter 230a. The auxiliary spacer (SCS) may be provided on a planar upper side (230a_s) of the first color filter 230a. The auxiliary spacer (SCS) may not overlap the second pixel area (PXb) and the third pixel area (PXc), and it may be separated from them. The auxiliary spacer (SCS) may not overlap the second color filter 230b and the third color filter 230c, and it may be separated from them. The auxiliary spacer (SCS) may not overlap the color filtering members 230D provided in the second pixel area (PXb) and the third pixel area (PXc).

The auxiliary spacer (SCS) may maintain the gap between the first display panel 100 and the second display panel 200 in a pressurized state. The main spacer (MCS) and the auxiliary spacer (SCS) may have different heights and/or different thicknesses. The height of the main spacer (MCS) may be greater than the height of the auxiliary spacer (SCS). The auxiliary spacer (SCS) need not be disposed in all the first pixel areas (PXa), and it may be provided in part of the first pixel areas (PXa).

Auxiliary spacers (SCS) may overlap the first transistor Qa and the second transistor Qb in a first pixel area (PXa). The auxiliary spacer (SCS) may, in a plan view, have a rectangular shape extending to the second transistor Qb from the first transistor Qa, and may have a protrusion protruding to a space between the first contact hole 185a and the second contact hole 185b. The auxiliary spacer (SCS) may have one or more of various forms.

The display device may include a main spacer (MCS) provided in the third pixel area (PXc) and an auxiliary spacer (SCS) provided in the first pixel area (PXc). A main spacer (MCS) and an auxiliary spacer (SCS) may be respectively provided on two pixels configured for displaying two different colors.

According to an embodiment, the third color filter 230c includes a first portion P1 overlapping the color filtering member 230D, and a second portion P2 not overlapping the color filtering member 230D. The thickness t1 of the first portion P1 is less than the thickness t2 of the second portion P2, and the upper side (230c_s) of the third color filter 230c has a substantially planar shape even though the third color filter 230c overlaps the color filtering member 230D.

The main spacer (MCS) is provided on a planar side of the third color filter 230c; therefore, it may be structurally stable. Particularly, even when the main spacer (MCS) is misaligned, since the third color filter 230c provides a planar upper side, the main spacer (MCS) may still have a stable and/or desirable height. The auxiliary spacer (SCS) is provided on a planar side of the first color filter 230a, so it may be structurally stable.

According to the embodiment described with reference to FIG. 1 and FIG. 2, each of the second pixel area (PXb) and the third pixel area (PXc) may include a color filtering member 230D. If each of the second color filter 230b and the third color filter 230c has a constant thickness in the entire region, the color filters 230b and 230c may have steps in the region in which the second color filter 230b overlaps the corresponding color filtering member (D) and the region in which the third color filter 230c overlaps the corresponding color filtering member (D). If a main spacer (MCS) is provided in the second pixel area (PXb) or the third pixel area (PXc) having a step, the main spacer (MCS) may not be stably provided on the step. The main spacer (MCS) provided on the step may not stably maintain the gap between the first display panel 100 and the second display panel 200.

The auxiliary spacer (SCS) may be spaced from the second display panel 200 with a substantially constant gap between the top face of the auxiliary spacer (SCS) and the second display panel 200, as shown in FIG. 3. However, if the auxiliary spacer (SCS) overlaps a step of the second pixel area (PXb) or the third pixel area (PXc), the gap between the second display panel 200 and the auxiliary spacer (SCS) may have different sizes. In this case, it may be difficult to stably maintain the gap between the first display panel 100 and the second display panel 200 through the auxiliary spacer (SCS) in the pressurized state.

In an embodiment, the main spacer (MCS) is provided on the third color filter 230c having a planar upper side, and the auxiliary spacer (SCS) is provided on the first color filter 230a having a planar upper side. Therefore, the main spacer (MCS) and the auxiliary spacer (SCS) may not be affected by steps and may be stably provided on the planar sides. Advantageously, satisfactory reliability of the display device may be attained.

A first alignment layer 11 may be provided on the electrodes 191a, 191b, and 199 and on the second insulating layer 180b

The first alignment layer 11 may be a vertical alignment layer. The first alignment layer 11 may be rubbed in at least one direction, and it may be a photo-alignment layer including a photo-reactive material.

The second display panel 200 may include a light blocking member 220 provided between a second substrate 210 (including an insulating material such as glass or plastic) and the liquid crystal layer 3. The light blocking member 220 may extend in the first direction DR1, and it may overlap the transistors Qa and Qb included in pixel areas PXa, PXb, and PXc. According to an embodiment, a light blocking member 220 may be provided not on the second display panel 200 but on the first display panel 100.

A common electrode 270 may be provided between the light blocking member 220 and the liquid crystal layer 3. The common electrode 270 may substantially cover an entire side of the second substrate 210. There may be no slits in the common electrode 270. The common electrode 270 may transmit a common voltage Vcom of a constant level.

The common electrode 270 may include a transparent conductive material such as ITO or IZO, or may include a metal thin film.

A second alignment layer 21 may be provided between the common electrode 270 and the liquid crystal layer 3. The second alignment layer 21 may be a vertical alignment layer. The second alignment layer 21 may be rubbed in at least one direction, and it may be a photo-alignment layer including a photo-reactive material.

The liquid crystal layer 3 includes a plurality of liquid crystal molecules 31. The liquid crystal molecules 31 may have negative dielectric anisotropy, and may be aligned in a substantially perpendicular direction with respect to the substrates 110 and 210 when no electric field is generated in the liquid crystal layer 3. The liquid crystal molecules 31 may be pre-tilted in a constant direction when no electric field is generated in the liquid crystal layer 3. For example, the liquid crystal molecules 31 may be pre-tilted substantially parallel to the branches 194a and 194b of the sub-pixel electrodes 191a and 191b.

A backlight for supplying light may be provided below or above the first display panel 100. As shown in FIG. 2 and FIG. 3, when the light from the backlight passes between the gate conductive layer (including the gate lines) and the data conductive layer (including the data lines), it may be partially reflected at the common electrode 270 of the second display panel 200, and the reflected light may be transmitted toward the first transistor Qa or the second transistor Qb of the first display panel 100. Most of the reflected light may be absorbed by the first color filter 230a and/or the color filtering member 230D, and the reflected light may not significantly affect the first transistor Qa or the second transistor Qb. Advantageously, satisfactory reliability of the display device may be attained.

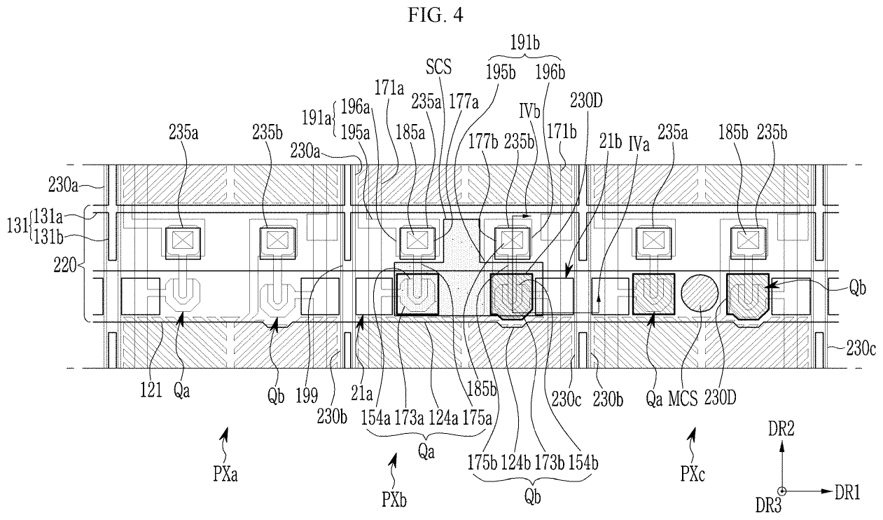

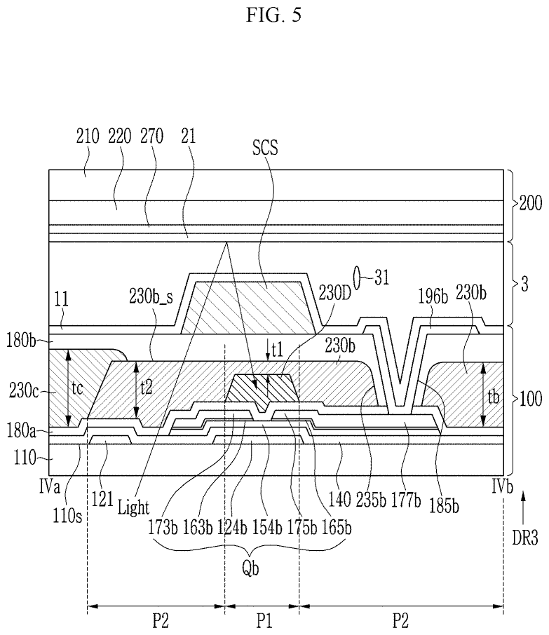

FIG. 4 shows a layout view of part of three adjacent pixel areas of a display device according to an embodiment, and FIG. 5 shows a cross-sectional view with respect to a line IVa-IVb shown in FIG. 4 according to an embodiment. Descriptions of elements identical or analogous to those described with reference to FIG. 1 to FIG. 3 may not be repeated.

The display device includes an auxiliary spacer (SCS) provided in the second pixel area (PXb). The auxiliary spacer (SCS) may overlap the second color filter 230b and the color filtering members 230D.

The auxiliary spacer (SCS) may overlap two color filtering members 230D overlapping the first transistor Qa and the second transistor Qb. The two color filtering members 230D may respectively overlap the first transistor Qa and the second transistor Qb. One auxiliary spacer (SCS) may overlap two color filtering members 230D.

The second color filter 230b includes a first portion P1 overlapping the color filtering member 230D and a second portion P2 excluding, positioned beyond, and/or directly connected to the first portion P1. The second color filter 230b may include a substantially planar upper side (230b_s). The upper side of the first portion P1 and the upper side of the second portion P2 may have the same height. A distance to the upper side of the first portion P1 from the upper side 110s of the first substrate 110 may be substantially equal to a distance to the upper side corresponding to the second portion P2 from the upper side 110s of the first substrate 110.

A thickness t1 of the first portion P1 may be different from a thickness t2 of the second portion P2. The thickness t1 of the first portion P1 may be less than the thickness t2 of the second portion P2. The first portion P1 may be formed to be relatively thin, compared to the second portion P2 in the second color filter 230b. Therefore, the first portion P1 may not protrude in the third direction DR3 beyond the second portion P2 and may not form a step. The first portion P1 may be formed through one or more of various processes, such as an exposure process using a halftone mask.

The auxiliary spacer (SCS) may be provided on the upper side of the second color filter 230b. The upper side (230b_s) of the second color filter 230b may have a substantially planar form.

The auxiliary spacer (SCS) may maintain the gap between the first display panel 100 and the second display panel 200 in the pressurized state. Auxiliary spacers (SCS) need not be disposed in tall second pixel area (PXb). Auxiliary spacers (SCS) may be provided in some second pixel areas (PXb).

An auxiliary spacer (SCS) may overlap the corresponding first transistor Qa and the corresponding second transistor Qb. In a plan view, the auxiliary spacer (SCS) may have a rectangular portion extending to the second transistor Qb from the first transistor Qa, and it may have a portion protruding to a gap between the first contact hole 185a and the second contact hole 185b. The auxiliary spacer (SCS) may have a T shape rotated by 180 degrees and/or a different structure in a plan view.

At least one auxiliary spacer (SCS) may overlap at least one of the first pixel area (PXa) and the second pixel area (PXb).

A main spacer (MCS) may overlap the third color filter 230c. A maximum thickness (tc) of the third color filter 230c may be relatively greater than a maximum thickness (tb) of the second color filter 230b. The main spacer (MCS) provided on the relatively thick third color filter 230c may be stably provided between the first display panel 100 and the second display panel 200.

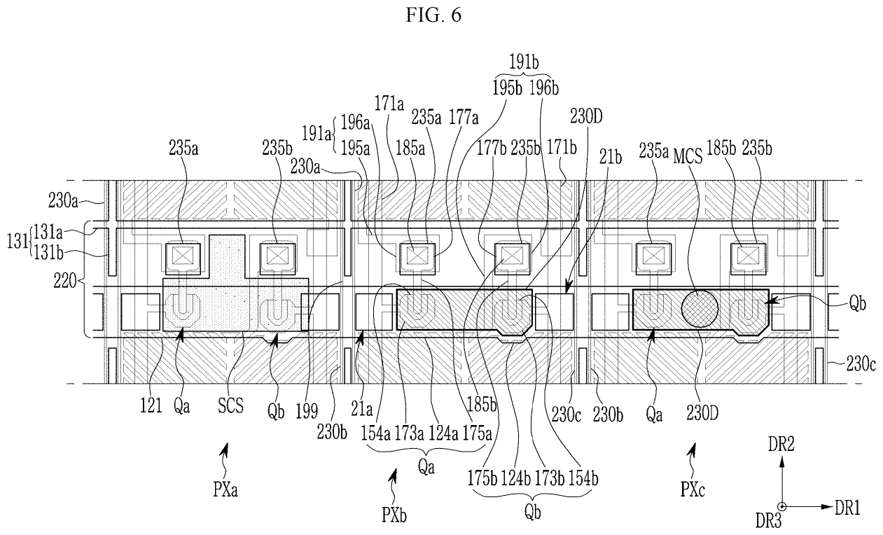

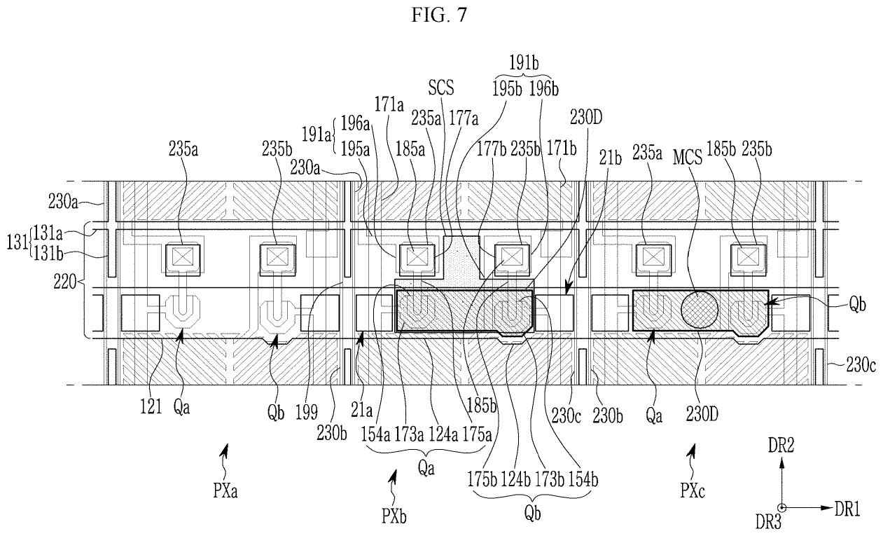

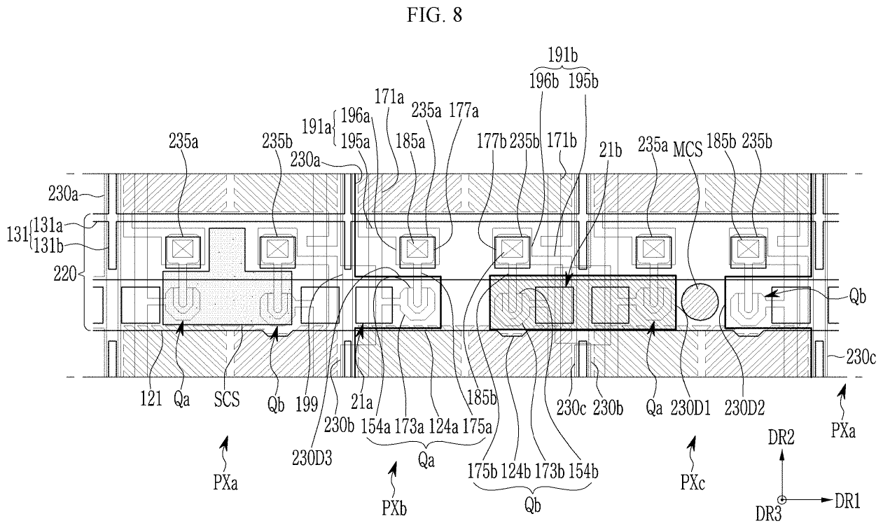

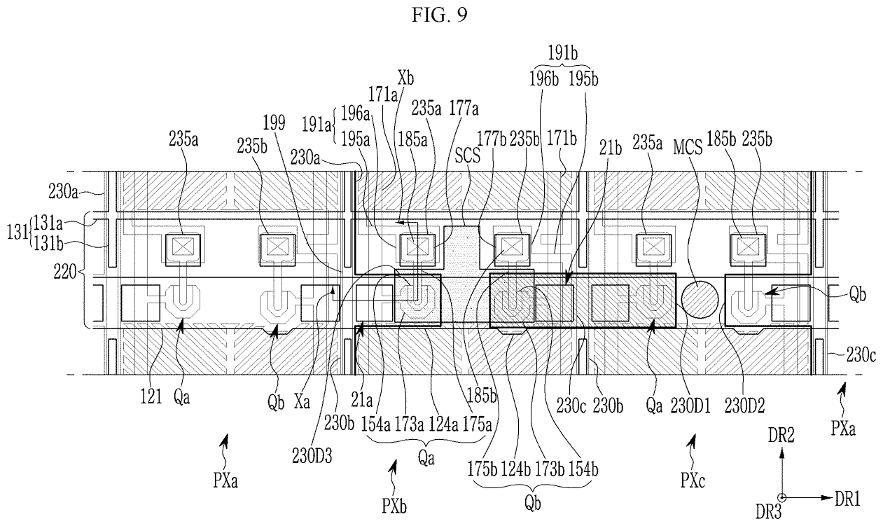

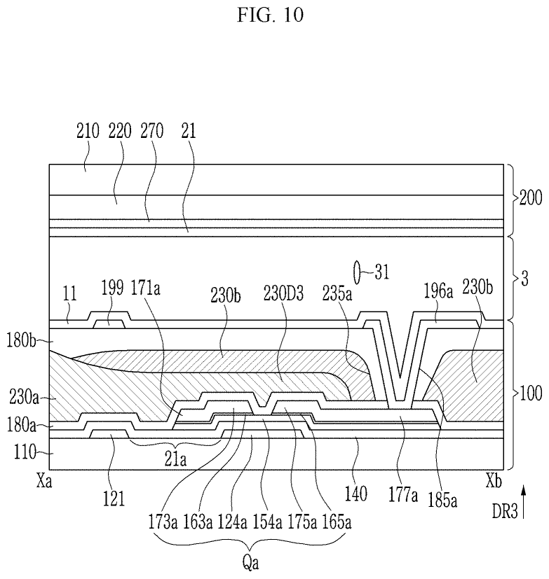

FIG. 6 shows a layout view of part of three adjacent pixel areas of a display device according to an embodiment, FIG. 7 shows a layout view of part of three adjacent pixel areas of a display device according to an embodiment, FIG. 8 shows a layout view of part of three adjacent pixel areas of a display device according to an embodiment, FIG. 9 shows a layout view of part of three adjacent pixel areas of a display device according to an embodiment, and FIG. 10 shows a cross-sectional view with respect to a line Xa-Xb of FIG. 9 according to an embodiment. Descriptions on elements identical or analogous to above-described elements may not be repeated.

Referring to FIG. 6, the display device shown in FIG. 6 may be analogous to the display device shown in FIG. 1 except for the color filtering members 230D.

The color filtering members 230D may overlap the second pixel area (PXb) and the third pixel area (PXc). Each of the color filtering members 230D overlapping the second pixel area (PXb) and third pixel area (PXc) may overlap both the corresponding first transistor Qa and the corresponding second transistor Qb and may extend in the first direction DR1 from the first transistor Qa to the second transistor Qb.

According to an embodiment, a length of a color filtering member 230D in the first direction DR1 may be greater than a length thereof in the second direction DR2. The first-direction length of the color filtering member 230D in the first direction DR1 may be greater than the second-direction length of the color filtering member 230D by about 30 micrometers.

A color filtering member 230D may overlap two transistors Qa and Qb. Advantageously, uniformity of the size of the color filtering member 230D may be efficiently managed in the process for manufacturing a display device, and undesirable peeling of the color filtering member 230D may be minimized or prevented.

A main spacer (MCS) may overlap the third pixel area (PXc), and an auxiliary spacer (SCS) may overlap the first pixel area (PXa), analogous to the structures described with reference to FIG. 1 to FIG. 3.

Referring to FIG. 7, the display device of FIG. 7 may be analogous to the display device of FIG. 4 except for the color filtering members 230D. The color filtering members 230D of FIG. 7 may be analogous to the color filtering members 230D of FIG. 6.

An auxiliary spacer (SCS) may overlap the second pixel area (PXb). The auxiliary spacer (SCS) may overlap the second color filter 230b and the corresponding color filtering member 230D.

The auxiliary spacer (SCS) may overlap both the corresponding first transistor Qa and the corresponding second transistor Qb. The auxiliary spacer (SCS) has a rectangular portion extending to the second transistor Qb from the first transistor Qa, and it may have a portion protruding to the gap between the first contact hole 185a and the second contact hole 185b, in a plan view. The auxiliary spacer (SCS) may have a T shape rotated by 180 degrees and/or a different structure in a plan view. auxiliary spacer

At least one auxiliary spacer (SCS) may overlap at least one of the first pixel area (PXa) and the second pixel area (PXb).

Referring to FIG. 8, the display device may be substantially analogous to the display device described with reference to FIG. 1, but structures of color filters 230a, 230b, and 230c may be different and may be provided on the same layer as the color filtering member 230D, and color filtering members 230D1, 230D2, and 230D3 having a different structure from the color filtering member 230D may be provided.

The first color filtering member 230D1 may be provided on the same layer as the first color filter 230a, which overlaps the first pixel area (PXa), may display the same color as the first color filter 230a, may be separated from the first color filter 230a or the first pixel area (PXa), and may be continuously formed in the adjacent pixel area PXb and PXc.

The color filtering member 230D1 may overlap the second transistor Qb provided on a right side of the second pixel area (PXb) and may overlap a first transistor Qa provided on a left side of the third pixel area (PXc). The first color filtering member 230D1 may overlap channels of the semiconductor layers 154a and 154b of the second transistor Qb provided on the right side of the second pixel area (PXb) and the first transistor Qa provided on the left side of the third pixel area (PXc). The first transistor Qa and the second transistor Qb of the two pixel areas PXb and PXc overlapping the same color filtering member 230D1 may be substantially arranged (and spaced from each other) in the first direction DR1.

The first color filtering member 230D1 may overlap the second data line 171b electrically connected to the second transistor Qb provided on the right side of the second pixel area (PXb) and may overlap the first data line 171a electrically connected to the first transistor Qa provided on the left side of the third pixel area (PXc).

The second color filtering member 230D2 may be provided on the same layer as the corresponding first color filter 230a, may display the same color as the first color filter 230a, may be directly connected to the left portion/edge of the first color filter 230a, and may overlap the second transistor Qb of the third pixel area (PXc) provided near the corresponding first pixel area (PXa). The second color filtering member 230D2 may overlap the channel of the second semiconductor layer 154b of the second transistor Qb of the third pixel area (PXc).

The third color filtering member 230D3 provided on the same layer as the corresponding first color filter 230a, may display the same color as the first color filter 230a, may be directly connected to the right portion/edge of the first color filter 230a, and may overlap the first transistor Qa of the second pixel area (PXb) provided near the first pixel area (PXa). The third color filtering member 230D3 may overlap the channel of the first semiconductor layer 154a of the first transistor Qa of the second pixel area (PXb).

The second color filtering member 230D2 and the third color filtering member 230D3 may not be separated from the corresponding first color filters 230a but may protrude from the first color filters 230a. Accordingly, one island-shaped first color filtering member 230D1 separated from the first color filters 230a may be provided in the three adjacent pixel areas PXa, PXb, and PXc. The first direction DR1 length of the first color filtering member 230D1 may be longer than the second direction DR2 length of the first color filtering member 230D1 by about 30 micrometers.

Only one island-shaped first color filtering member 230D1 may be required for three adjacent pixel areas PXa, PXb, and PXc. Advantageously, uniformity of the size of the color filtering member 230D1 may be efficiently managed in the process for manufacturing a display device, and undesirable peeling color filtering members 230D1, 230D2, and 230D3 may be minimized or prevented.

Most of the light that is transmitted toward the channels of the transistors Qa and Qb from the top is absorbed by the color filtering members 230D1, 230D2, and 230D3 and may not significantly affect the transistors Qa and Qb. Therefore, initial threshold voltages of the transistors Qa and Qb may be optimized, variations of the threshold voltages may be minimized, and unwanted changes of colors of in displayed images may be minimized. Advantageously, satisfactory reliability of the display device may be attained.

The color filtering members 230D1, 230D2, and 230D3 may overlap the light blocking member 220 is provided.

Regarding the display device described with reference to FIG. 8, a main spacer (MCS) may overlap the third pixel area (PXc), and an auxiliary spacer (SCS) may overlap the first pixel area (PXa). The main spacer (MCS) and the auxiliary spacer (SCS) may be analogous to structures described with reference to FIG. 1 to FIG. 3.

The display device shown in FIG. 9 and FIG. 10 may be substantially analogous to the display device described with reference to FIG. 4, but the structures of color filters 230a, 230b, and 230c may be different, they may be provided on the same layer as the color filtering member 230D, and color filtering members 230D1, 230D2, and 230D3 structurally different from the color filtering member 230D may be provided. The structures of color filters 230a, 230b, and 230c included by a display device shown with reference to FIG. 9 and FIG. 10 and the color filtering members 230D1, 230D2, and 230D3 may be analogous to those described with reference to FIG. 8.

A main spacer (MCS) may overlap the third pixel area (PXc), and an auxiliary spacer (SCS) may overlap the second pixel area (PXb). The auxiliary spacer (SCS) may include a left region/portion overlapping the third color filtering member 230D3 and may include a right region/portion overlapping the first color filtering member 230D1. The right region/portion may be connected through an intermediate portion to the left region/portion, and the intermediate portion may protrude in the second direction DR2 toward the first sub-pixel electrode 191a.

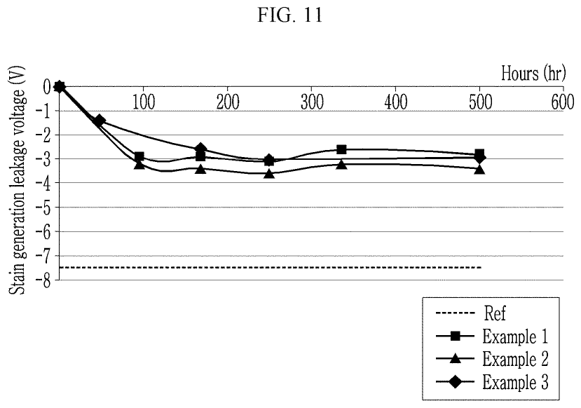

FIG. 11 shows a graph of a stain generating leakage voltage according to an embodiment. The display device corresponding to FIG. 11 includes a color filtering member overlapping the second color filter and the third color filter.

FIG. 11 shows a graph of variation degrees of a stain generating leakage voltage of a display device according to Examples 1, 2, and 3 as the time passes up to about 500 hours. In the Examples 1, 2, and 3, a backlight unit is 870,000 nits, and the stain generating leakage voltage after 500 hours is about −3.9 V. There is a margin voltage of about 3.6 V in comparison to a reference value (Ref) with which a stain is visible.

For a display device including no color filtering member according to a comparative example, the backlight unit is 500 nits, the stain generating leakage voltage after 500 hours is about −4.5 V, and the margin voltage is about 3 V for the reference value (Ref) with which a stain is generated.

Generation of a stain corresponds to luminance recognized to be bright compared to a surrounding area. A greater difference between a predetermined reference value and the stain generating leakage voltage, i.e., a greater margin voltage, may correspond to easier control of a phenomenon that a user perceives the change of stain. The margin voltage according to an example embodiment may be significantly larger than the margin voltage according to the comparative example, so it may be easy to control generation of stains with the embodiment. As the amount of light emitted by the backlight unit increases, the generation of stains may be less conspicuous, but the margin voltage on the generation of stains is improved by providing a color filter overlapping the transistor. Further, as the main spacer and the auxiliary spacer are stably formed not on a step but on a planar face, satisfactory durability of the display device may be attained. It may be found through smear estimation what degree of force the display device may sustain, and it is found that the smear characteristic may be improved in the example embodiments in comparison to the comparative example.

In embodiments, a big liquid crystal margin section is implemented, such that an active unfilled area (AUA) defect (caused by insufficient liquid crystal at a portion of the display device) may be prevented, and such that light leakage may be prevented. With uniform provision of the main spacer and the auxiliary spacer, a gravity defect that is generated by excessively filling liquid crystal may be prevented. As a space between the first display panel and the second display panel is stably maintained by the spacers, a sufficient liquid crystal margin section may be obtained.

The margin on the stain generating voltage is desirably maintained according to example embodiments. Therefore, the initial threshold voltage may be optimized, and unwanted variation of the threshold voltage may be minimized, such that unwanted change of colors of displayed images may be minimized. Advantageously, satisfactory reliability of the display device may be attained.

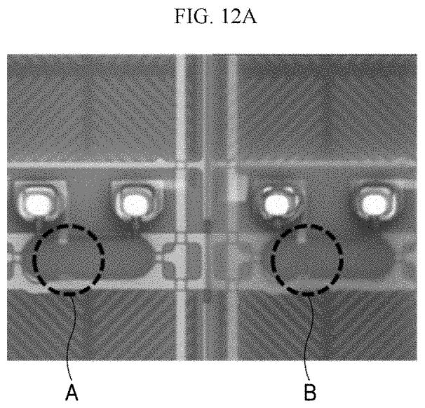

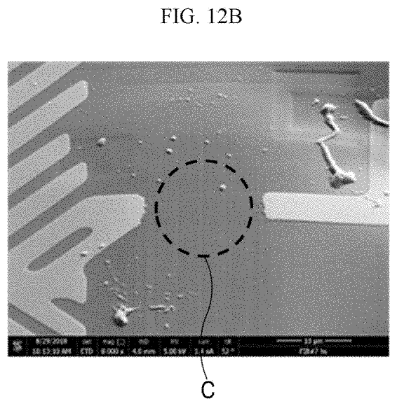

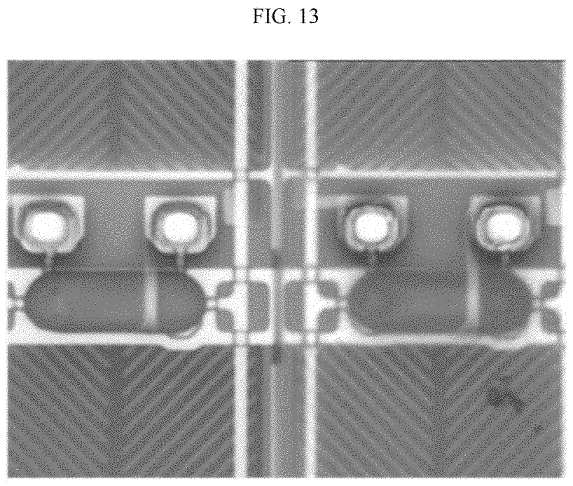

Each of FIG. 12A and FIG. 12B shows an image on part of a region of a display device according to a comparative example, and FIG. 13 shows an image of part of a region of a display device according to an embodiment.

Referring to FIG. 12A and FIG. 12B, in a comparative example, the second color filter and the third color filter overlapping the color filtering member are provided with the same thickness, an extension of the pixel electrode connected through a contact hole is disconnected in each of the areas A, B, and C. Consequently, the pixel electrode may not receive a data voltage, and the pixel area including the pixel electrode becomes a defective pixel.

When the thickness of the color filter overlapping the color filtering member is constantly provided according to a comparative example, the color filter may have a protruding step in the region overlapping the color filtering member. Conductive portions belonging to the pixel electrode layer and provided on the step may be removed in the areas A, B and C in the grinding repair process. Accordingly, the display device may include about 8.5% of defective pixels.

In an embodiment illustrated in FIG. 13, as the color filter does not protrude by the color filtering member, the pixel electrode and associated conductive parts are not damaged when the grinding repair process is performed.

While example embodiments have been described, practical embodiments are not limited to the described embodiments. Practical embodiments cover various modifications and equivalent arrangements within the scope of the appended claims.

What is claimed is:

1. A display device comprising:
a substrate, wherein a first direction is parallel to a face of the substrate, wherein a second direction is parallel to the face of the substrate and is perpendicular to the first direction, wherein a third direction is perpendicular to the face of the substrate;
a first transistor overlapping the face of the substrate;
a first pixel electrode electrically connected to the first transistor;
a first color filter overlapping the first pixel electrode;
a first color filtering member including a same material as the first color filter;
a second color filter partially overlapping the first color filter or immediately neighboring the first color filter;
a third color filter overlapping the first color filtering member, spaced from the first color filter, and partially overlapping the second color filter or immediately neighboring the second color filter;
a main spacer overlapping the third color filter; and
an auxiliary spacer overlapping at least one of the first color filter and the second color filter and being shorter than the main spacer in the third direction,
wherein the third color filter includes a first portion and a second portion,
wherein the first portion overlaps the first color filtering member, and
wherein the second portion neighbors the first portion in the first direction and is thicker than the first portion in the third direction.

2. The display device of claim 1, wherein the auxiliary spacer overlaps the first color filter.

3. The display device of claim 1, wherein a face of the first portion is spaced from the first color filtering member, is parallel to the face of the substrate, and is coplanar with a face of the second portion.

4. The display device of claim 1, wherein the second color filter overlaps the auxiliary spacer.

5. The display device of claim 4, further comprising a second color filtering member including the same material as the first color filter, wherein the auxiliary spacer overlaps the second color filtering member.

6. The display device of claim 4, wherein the auxiliary spacer is wider than the second color filtering member in the first direction.

7. The display device of claim 1, further comprising a second color filtering member including the same material as the first color filter,
wherein the second color filter includes a first part and a second part,
wherein the first part overlaps the second color filtering member,
wherein the second part neighbors the first part in the first direction, and
wherein a face of the first part is spaced from the second color filtering member, is parallel to the face of the substrate, and is coplanar with a face of the second part.

8. The display device of claim 7, further comprising:
a second pixel electrode overlapping the second color filter and comprising a first sub-pixel electrode and a second sub-pixel electrode;
a second transistor electrically connected to the first sub-pixel electrode; and
a third transistor electrically connected to the second sub-pixel electrode,
wherein the second color filtering member overlaps both the second transistor and the third transistor, and wherein the auxiliary spacer overlaps both the second transistor and the third transistor.

9. The display device of claim 1, wherein a maximum thickness of the third color filter in the third direction is greater than each of a maximum thickness of the first color filter in the third direction and a maximum thickness of the second color filter in the third direction.

10. The display device of claim 1, wherein the first color filter is a red color filter, and wherein the third color filter is a blue color filter.

11. The display device of claim 1, further comprising:
a second pixel electrode overlapping the second color filter;
a second transistor electrically connected to the second pixel electrode;
a second color filtering member overlapping the second transistor, wherein the second color filter overlaps the second color filtering member;
a third pixel electrode overlapping the third color filter; and
a third transistor electrically connected to the third pixel electrode, wherein the first color filtering member overlaps the third transistor.

12. The display device of claim 1, further comprising:
a second transistor electrically connected to the first pixel electrode;
a first sub-pixel electrode overlapping the third color filter;
a second sub-pixel electrode overlapping the third color filter;
a third transistor electrically connected to the first sub-pixel electrode; and
a fourth transistor electrically connected to the second sub-pixel electrode, wherein the main spacer is provided between the third transistor and the fourth transistor.

13. The display device of claim 12,
wherein the auxiliary spacer includes a first part and a second part,
wherein the first part overlaps both the first transistor and the second transistor, and
wherein the second part protrudes in the second direction from the first part.

14. The display device of claim 1, further comprising:
a first sub-pixel electrode overlapping the third color filter;
a second sub-pixel electrode overlapping the third color filter;
a second transistor electrically connected to the first sub-pixel electrode; and
a third transistor electrically connected to the second sub-pixel electrode,
wherein the first color filtering member overlaps both the second transistor and the third transistor.

15. A display device comprising:
a first substrate;
a second substrate overlapping the first substrate;
a liquid crystal layer positioned between the first substrate and the second substrate;
a transistor overlapping a face of the first substrate and is positioned closer to the first substrate than to the second substrate;
a first color filter, a second color filter, and a third color filter overlapping the face of the first substrate, wherein the second color filter is substantially positioned between the first color filter and the third color filter;
a pixel electrode electrically connected to the transistor and overlapping at least one of the first color filter, the second color filter, and the third color filter;
a color filtering member including a same material as the first color filter and overlapping the second color filter or the third color filter;
a main spacer and an auxiliary spacer positioned between the first substrate and the second substrate,
wherein a first face of the first color filter is positioned between the second substrate and a second face of the first color filter,
wherein a first face of the second color filter is positioned between the second substrate and a second face of the second color filter,
wherein the first face of the first color filter is substantially coplanar with the first face of the second color filter, and
wherein the auxiliary spacer is shorter than the main spacer in a direction perpendicular to the face of the first substrate, overlaps at least one of the first color filter and the second color filter, and is provided between first substrate and the liquid crystal layer.

16. The display device of claim 15, wherein a first face of the third color filter is positioned between the second substrate and a second face of the third color filter and is positioned closer to the second substrate than the first face of the first color filter is positioned.

17. The display device of claim 15, wherein the third color filter overlaps the main spacer.

18. The display device of claim 15, wherein the auxiliary spacer overlaps both the second color filter and the color filtering member.

19. The display device of claim 15, wherein the main spacer overlaps the color filtering member.

20. The display device of claim 15, wherein the main spacer is separated from the color filtering member in a plan view of the display device.
